(19) United States
(12) Patent Application Publication
(10) Pub. No.: US 2026/0339719 A1
(43) Pub. Date: Oct. 29, 2026

(54) RETRIEVAL-AUGMENTED GENERATION ARCHITECTURE FOR MODEL SELECTION

(71) Applicant: The Toronto-Dominion Bank, Toronto (CA)

(72) Inventors: Mohammad Ghasemi Damavandi, Toronto (CA); Rustam Vosilov, Montreal (CA)

(73) Assignee: The Toronto-Dominion Bank, Toronto (CA)

(21) Appl. No.: 19/187,751

(22) Filed: Apr. 23, 2025

(51) Int. Cl. G06F 9/50; G06F 16/242; G06F 40/40

(52) U.S. Cl. CPC G06F 9/5027; G06F 16/243; G06F 40/40

(57) ABSTRACT

An example operation may include at least one of receiving, from a source device, a natural language input from a chat window of a software application, identifying a task to be performed and a type of data to be used by the task to be performed from the natural language input, selecting an artificial intelligence (AI) model for the task to be performed from among a plurality of different AI models stored within a database based on execution of at least one additional AI model on the task and the type of data, and transferring at least one of an identifier of an executable file or the executable file of the selected AI model to the chat window of the software application. The example operation may further include an AI agent performing an action related to the transferring.

### BACKGROUND

Retrieval-Augmented Generation (RAG) is an artificial intelligence (AI) framework that combines models, e.g., large language models (LLMs), with information retrieval systems. RAG can be used to improve the accuracy and relevance of generated responses by ensuring up-to-date and relevant information is used. For example, the RAG system may receive a natural language input, and in response, may generate a natural language output. The response may be bolstered by, or informed by, a series of documents that are “retrieved” by the RAG framework and which are highly related to the natural language input enabling the RAG framework to generate an accurate natural language response.

### SUMMARY

One example embodiment provides an apparatus that includes a memory and at least one processor communicatively coupled to the memory, wherein the at least one processor may at least one of receive, from a source device, a natural language input from a chat window of a software application, identify a task to be performed and a type of data to be used by the task to be performed from the natural language input, select an artificial intelligence (AI) model for the task to be performed from among a plurality of different AI models stored within a database based on execution of at least one additional AI model on the task and the type of data, and transfer at least one of an identifier of an executable file or the executable file of the selected AI model to the chat window of the software application.

Another example embodiment provides a method that includes at least one of receiving, from a source device, a natural language input from a chat window of a software application, identifying a task to be performed and a type of data to be used by the task to be performed from the natural language input, selecting an artificial intelligence (AI) model for the task to be performed from among a plurality of different AI models stored within a database based on execution of at least one additional AI model on the task and the type of data, and transferring at least one of an identifier of an executable file or the executable file of the selected AI model to the chat window of the software application.

A further example embodiment provides a computer readable storage medium comprising instructions, that when read by a processor, cause the processor to perform at least one of receiving, from a source device, a natural language input from a chat window of a software application, identifying a task to be performed and a type of data to be used by the task to be performed from the natural language input, selecting an artificial intelligence (AI) model for the task to be performed from among a plurality of different AI models stored within a database based on execution of at least one additional AI model on the task and the type of data, and transferring at least one of an identifier of an executable file or the executable file of the selected AI model to the chat window of the software application.

### BRIEF DESCRIPTION OF DRAWINGS

FIG. 1A is a diagram illustrating an operating environment with a RAG architecture according to examples and features of the instant solution.

FIG. 1B is a diagram illustrating a chat window which transfers model content using the RAG architecture show in the example of FIG. 1A, according to the examples and features of the instant solution.

FIG. 1C is a diagram illustrating another operating environment with a RAG architecture according to examples and features of the instant solution.

FIG. 2A is a system diagram illustrating integration of an A I model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 2D is a system diagram illustrating a chatbot service that utilizes an AI model.

FIG. 3 is a system diagram illustrating an operating environment for a RAG-based framework according to the examples and features of the instant solution.

FIG. 4A is a diagram illustrating a process of retrieving an AI model according to the examples and features of the instant solution.

FIG. 4B is a diagram illustrating a process of retrieving training data and model tests according to the examples and features of the instant solution.

FIG. 5 is a diagram illustrating a process of validating an AI model prior to delivering the AI model according to the examples and features of the instant solution.

FIG. 6 is a diagram illustrating a process of retraining an AI model according to the examples and features of the instant solution.

FIG. 7A is a diagram illustrating a method for recommending an AI model according to the examples and features of the instant solution.

FIG. 7B is a diagram illustrating an additional method for recommending an AI model according to the examples and features of the instant solution.

FIG. 8 is a system diagram illustrating a computing environment according to the instant solution's example features, structures, or characteristics.

### DETAILED DESCRIPTION

A retrieval-augmented generative (RAG) software architecture that combines information retrieval systems with AI models, e.g., LLMs. A traditional use case for a RAG software architecture is within a chat application. Here, the RAG architecture may be responsible for conducting a conversation with an end user. The end user may query the RAG architecture with natural language (e.g., questions, etc.). A retriever within the RAG architecture may identify document content (that's been stored as vectors) which is related to the natural language query using similarity analysis in vector space. The retriever may pass the identified document content along with the natural language query to the LLM, which generates a response to the natural language query using the identified document content. The use of the additional document content makes the responses more relevant and more specific to the needs of the end user in comparison to a generic AI model that does not use RAG.

The example embodiments leverage some of the principles of a RAG software architecture for purposes of identifying and providing optimum AI models to an end user that provides a natural language input to a chat window or other communication interface of a software application such as a chat application. The end user may input a natural language query or other input which describes a predictive task that is needed, a type of data that the predictive task will be performed on, and the like. The system may identify the predictive task and the type of data from the natural language input, and determine an optimum AI model for such predictive task combined with the type of data. In some cases, the system may use at least one AI model which is trained to identify an optimum AI model based on predictive tasks, data types, and other attributes.

The system may not only identify the most optimum AI model for the task in combination with the type of data, but also share an executable of the optimum AI model with the end user via the chat window of the application. For example, the user may input a natural language query, and the system may return an AI model, a description of the AI model such as what it does, who designed, how old it is, what kind of it works with, the type of training data used, the type of tests used, and the like. The natural language query may specify a task such as “fraud prediction”, “signature verification”, “biometric authentication”, and the like. The natural language query may also specify a type of data such as credit card data, document data, fingerprint data, and the like.

The system described herein may be trained to identify a most optimum model for a particular task in combination with the data to be used for the particular task. The system may also have certain requirements that it needs before it can predict the most optimum model. For example, the system may need to capture a certain set of parameters from the natural language query of the user. If the parameters are not found within the query (e.g., the predictive task, the type of data, etc.), the system may generate a natural language response with a question or other request for such data. When the system determines it has the necessary parameter values, it then determines the optimum AI model and can post a file or other executable of the optimum AI model within the chat window where it can be downloaded or otherwise transferred to a source device that is sharing the chat window.

Some of the benefits of the example embodiments include using a RAG architecture in a unique way to enable a system to respond to natural language queries with optimum AI model content, training data, tests used during training, and the like. The system can provide a developer with a head start on any new model the developer is needing to develop. The system can also provide the user with source code that has been validated against internal coding standards, external coding standards, best practices, and the like, thereby ensuring the usability of the code.

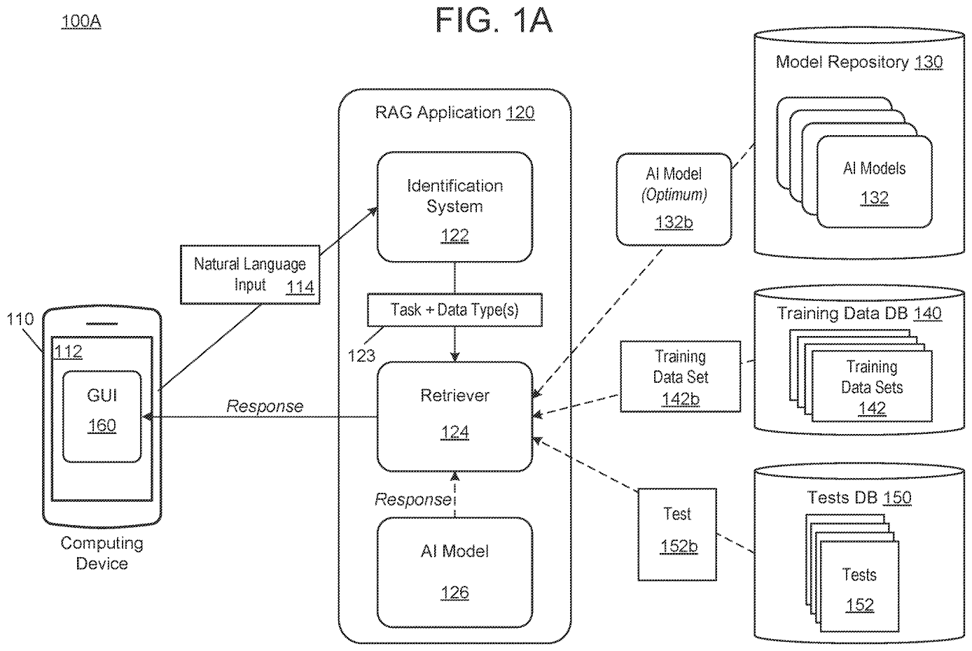

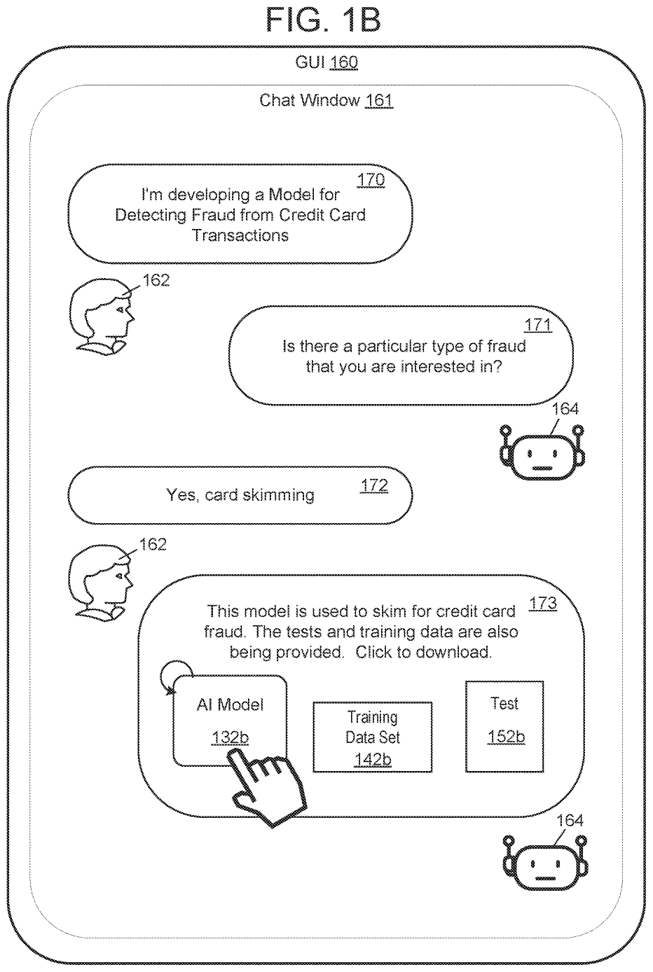

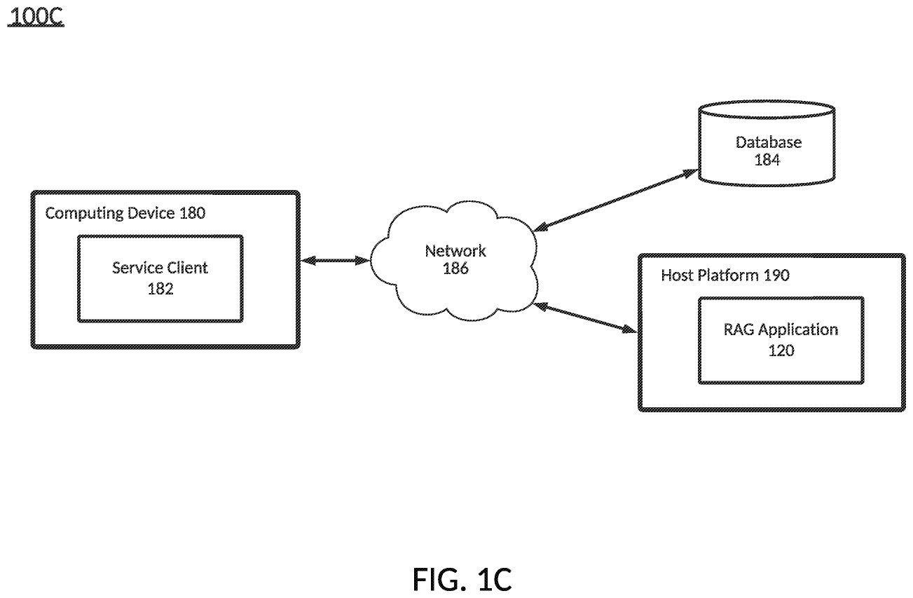

FIG. 1A illustrates an operating environment 100A with a RAG architecture according to examples and features of the instant solution. Referring to FIG. 1A, an end user may use a computing device 110 to query a RAG application 120 for an optimum AI model, training data, model tests, executable files, source code segments, and the like. For example, the RAG application 120 may be hosted by a host platform 190 (shown in FIG. 1C). The computing device 110 may connect to the host platform 190 (and the RA G application 120) over a computer network.

In this example, the RAG application 120 includes an identification system 122 and a retriever 124. The identification system 122 can receive a natural language input 114 that is submitted from a graphical user interface (GUI) 160 of the RAG application 120. The natural language input 114 may include a question, a query, a request, or the like. As an example, the natural language input 114 may identify/describe a predictive task that is to be performed, and a type of data that the task will be performed on.

The identification system 122 may receive the natural language input 114 and identify attributes 123 of the natural language input 114 that are to be used by the retriever 124 to identify an optimum AI model or optimum group of AI models. In this example, the attributes 123 are provided to the retriever 124. The retriever 124 may include at least one additional model that can determine the most optimum AI model or top N optimum AI models. For example, the retriever 124 may identify an optimum AI model 132b from a plurality of AI models 132 stored within a model repository 130.

In some embodiments, the retriever 124 may also retrieve a training data set 142b that is used to train the optimum AI model 132b. The training data set 142b may be retrieved from a training data database 140, for example, based on an identifier of the optimum AI model 132b, a pointer stored in the metadata of the optimum AI model 132b, or the like. In some embodiments, the retriever 124 may also retrieve at least one test 152 that is used to train the optimum AI model 132b, for example, a test 152b. In some embodiments, the test 152b may include a test script, test data, and the like, used during the training. The test 152b may be retrieved from a test database 150, for example, based on an identifier of the optimum AI model 132b, a pointer stored in the metadata of the optimum AI model 132b, or the like.

The retriever 124 may post at least one of the optimum AI model 132b, the training data set 142b, and the test 152b, within a chat window 161 of the GUI 160 as shown in the example of FIG. 1B. The retriever 124 may post a name of the optimum AI model 132b. As another example, the retriever 124 may post an executable file of the optimum AI model 132b within the chat window 161. The retriever 124 may also post source code, data files, table data, tests, testing scripts, test data, and the like, within the chat window 161.

FIG. 1B illustrates the GUI 160 with a chat window 161 which can be displayed on a display device 112 on the computing device 110, and which transfers model content using the RAG architecture show in the example of FIG. 1A, according to the examples and features of the instant solution. Referring to FIG. 1B, the chat window 161 includes a plurality of chat messages and content messages that have been posted within the chat window 161. Here, a user includes an avatar 162 that represents natural language inputs from the user and a chatbot 164 outputs responses and model content from the RAG application 120. In this example, the user provides a first natural language input 170.

In response, the RAG application 120 determines that a data value needed for predicting the optimum AI model is missing. In this case, the system detects the task (fraud detection), the data type (credit card data), but it's missing a specific sub-type of fraud. Here, the RA G application 120 may use an AI model 126 (shown in FIG. 1A) to generate a natural language response 171 and post it within the chat window 161 because the data needed for predicting the optimum AI model is missing one or more parameter values. In response, the user provides the missing value through an additional natural language input 172.

In response, the RAG application 120 identifies the optimum AI model 132b based on the parameters in the natural language input, and posts a response 173 with an executable file of the optimum AI model 132b in the chat window 161 of the GUI 160. The RAG application 120 also posts a data file including the training data sets 142 and an executable including the test 152b within the chat window 161. By posting it in the chat window 161, the user can simply click on or otherwise accept the files and download them locally enabling the optimum AI model 132b, the training data set 142b, and the test 152b, to be shared with the user.

Here, the chat window 161 within the GUI 160 is shared with the computing device 110. A user of the computing device 110 can use a cursor, a touch/click, key input, or other input means to select the executable file, data file, etc., and download the content from the chat window 161 where it is added by the RAG application 120, locally to the computing device 110.

FIG. 1C illustrates another example of an operating environment 100C of the instant solution. As shown, at least one computing device 180, and a host platform 190 communicate via a network 186. The host platform 190 may host the RA G application 120 described in the examples of FIGS. 1A and 1B. The RAG application 120 may communicate with at least one database 184 through the network 186 during the course of service execution. Each computing device 180 may host a service client 182, which communicates with a corresponding RAG application 120.

A computing device 180 may be a mobile phone, tablet, laptop computer, desktop computer, smartwatch, vehicle infotainment system, or any computing device including a processor and memory. The host platform 190 may include a single physical server, multiple physical servers, a cloud hosting environment, or a hybrid hosting environment in which some components of the host platform 190 are “on-premise” while others are cloud-hosted. The network 186 is a computer network and may include at least one interconnected computer network. For example, network 186 may be or may include an Ethernet network, an asynchronous transfer mode (ATM) network, a wireless network, a telecommunications network or the like.

The RAG application 120 provides the service logic. It may provide at least one Application Programming Interface (API) for communicating with the RAG application 120. A “thick” user interface client that runs on the computing device 180 may utilize the APIs to communicate with the RA G application 120. Further, the RA G application 120 may provide hosted User Interfaces (Uls) that can be accessed through browser-based software on the computing device 180.

The RAG application 120 can enable service access for end users and may come in a variety of forms including, but not limited to, a mobile device application (“app”) or a web portal accessed via a browser on a computing device 180 such as a laptop or desktop computer.

Detailed descriptions of the architecture and operation of the retrieval service in the instant solution are further described and depicted herein.

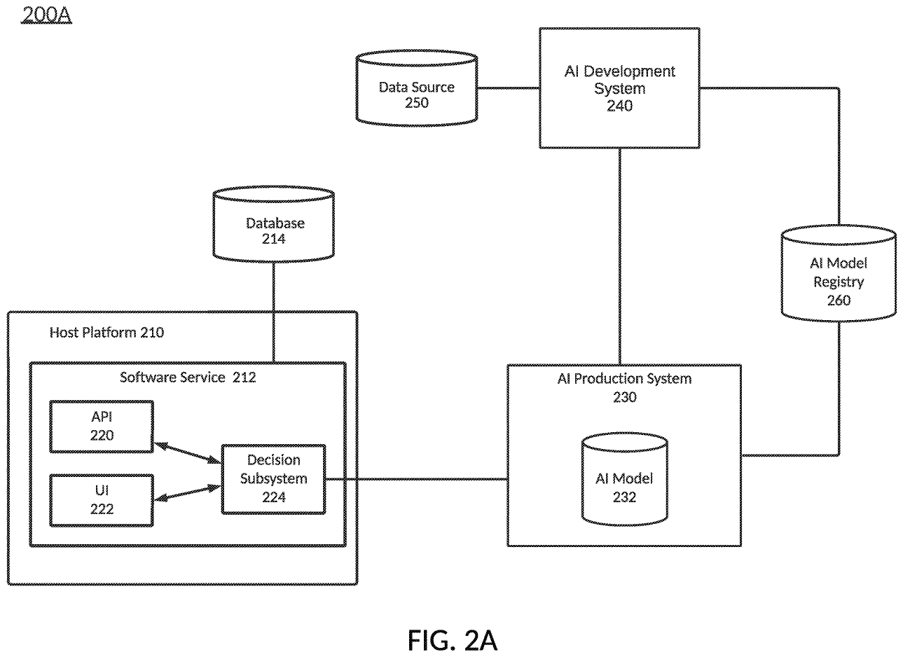

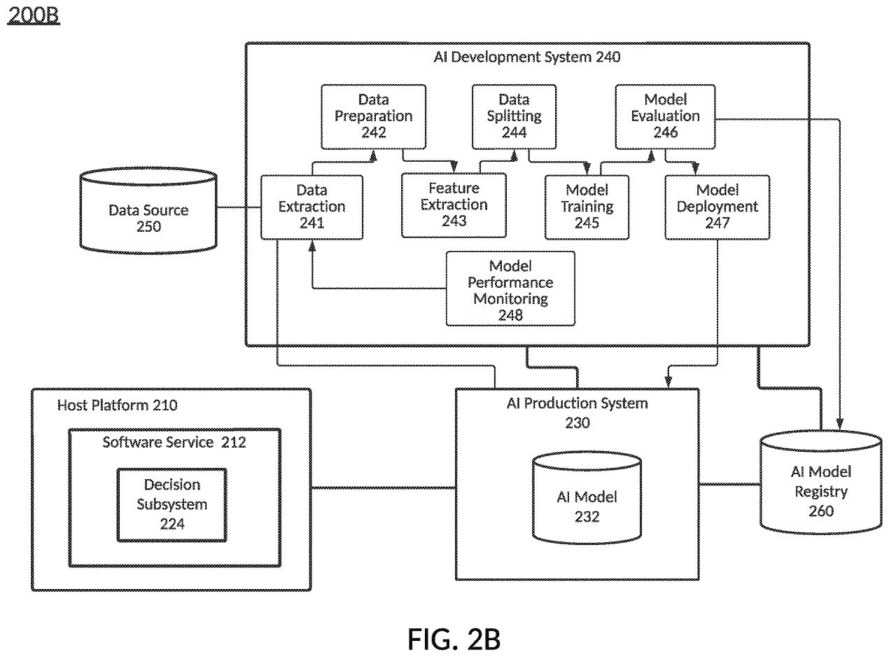

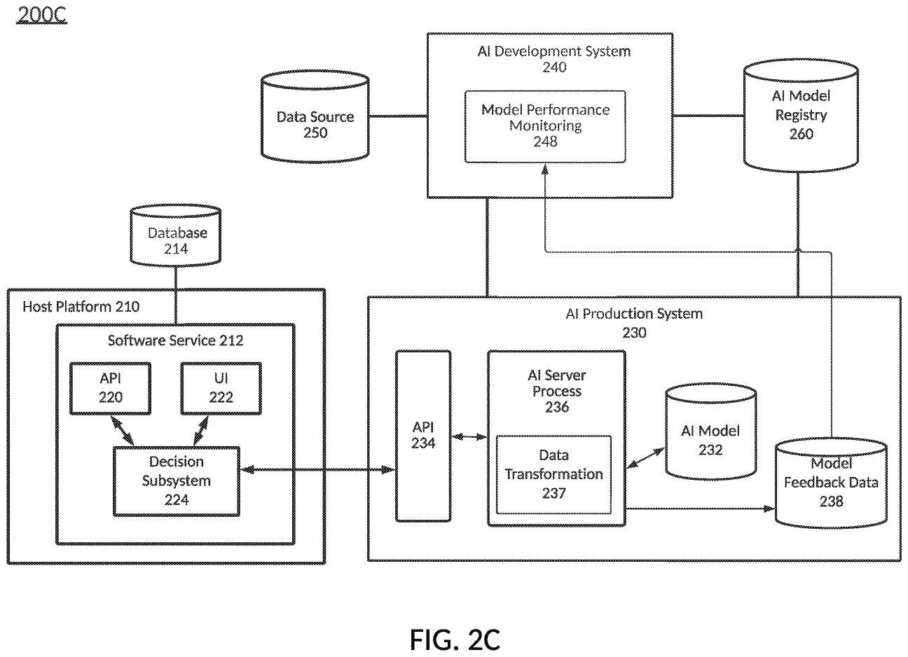

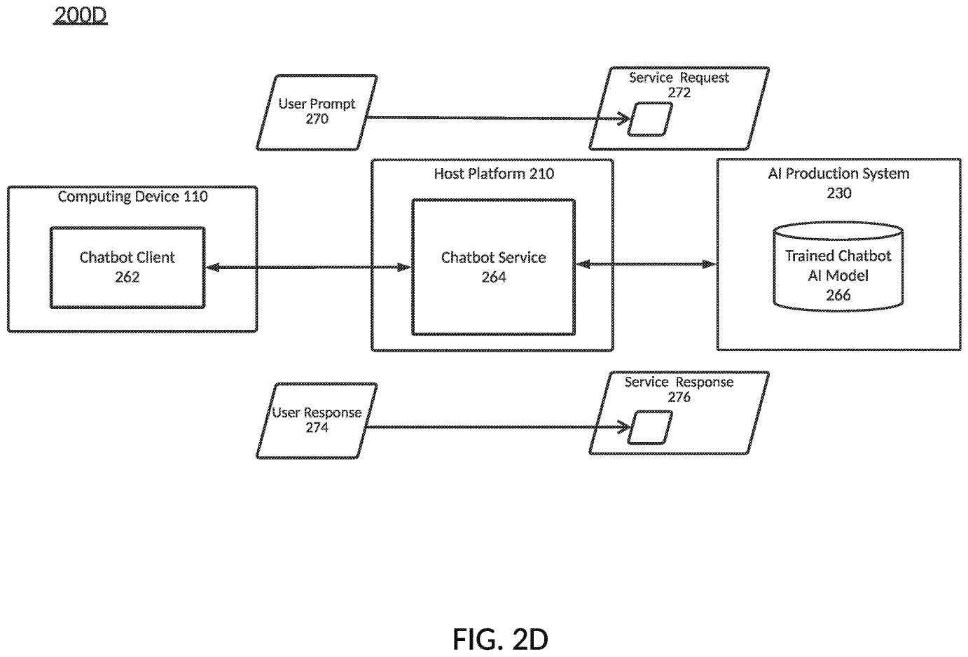

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative A I models, and any future A I models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 212, executing on host platform 210 may provide at least one A PI 220 that enable interaction with other software components via a set of data definitions and protocols. In some examples and features of the instant solution, the at least one A PI provided may employ Simple Object Access Protocol (SOAP), Remote Procedure Calls (RPC), and Representational State Transfer (REST) techniques. In some examples and features of the instant solution, the plurality of A Pls 220 send data to at least one decision subsystem 224 of the software service 212 to assist in decision-making. In some examples and features of the instant solution, the software service 212 stores data included in API requests or data generated during processing the API requests into at least one database 214. In some examples and features of the instant solution, software service 212 is a chatbot service.

Software service 212 may provide at least one user interface (UI) 222, such as a server-side hosted graphical user interface (GUI). In some examples and features of the instant solution, the Uls 222 provided employ template-based frameworks, component-based frameworks, etc. In some examples and features of the instant solution, these UIs 222 send data to at least one decision subsystem 224 of the software service 212 to assist with decision-making. In some examples and features of the instant solution, the software service 212 stores data included in UI requests or data generated during processing the UI requests into at least one database 214.

Software service 212 may include at least one decision subsystem 224 that drive a decision-making process of the software service 212. In some examples and features of the instant solution, the decision subsystems 224 receive data from at least one A PI 220 as input into the decision-making process. In some examples and features of the instant solution, a decision subsystem 224 may receive data from at least one UI 222 as input to the decision-making process. A decision subsystem 224 may gather service configuration or historical execution data from at least one database 214 to aid in the decision-making process. A decision subsystem 224 may provide feedback to an A PI 220 or a UI 222.

An AI production system 230 may be used by a decision subsystem 224 in a software service 212 to assist in its decision-making process. The AI production system 230 includes at least one AI model 232 that is executed to generate a response, such as, but not limited to, a prediction, a categorization, a UI prompt, etc. In some examples and features of the instant solution, the AI model 232 has been trained to provide chatbot responses. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from the AI production system 230.

Once the data has been extracted during the data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the A I model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The A I model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the AI production system 230. This evaluation uses a validation dataset to ensure the performance in the AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to the AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an A PI 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include A PI 220 data from software service 212, UI 222 data from software service 212 or data from other software service 212 subsystems (not shown).

Upon receiving the A PI 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the A PI requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the A I server process 236.

In some examples and features of the instant solution, the A PI 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the A PI 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the AI production system 230, and the operation of the AI production system and its components.

FIG. 2D illustrates a process 200D of a chatbot service that utilizes an AI model. Referring to FIG. 2D, the computing device 110 may host a chatbot client 262 which interworks with a chatbot service 264 executing on the host platform 210. Further, the chatbot service 264 utilizes a trained chatbot AI model 266 that is resident on an AI production system 230. In some examples and features of the instant solution, the chatbot client 262 is an example of a service client 182, depicted in FIG. 1C. In some examples and features of the instant solution, the chatbot service 264 is an example of software service 212 which includes an API 220, a UI 222 and at least one decision subsystem 224. In some examples and features of the instant solution, the trained chatbot AI model 266 is an example of AI model 232 which is hosted on an AI production system 230. In some examples and features of the instant solution, the AI production system 230 includes the internal architectural elements depicted in FIG. 2C.

The chatbot client 262 accepts and captures a user prompt 270 which it sends to the chatbot service 264. Upon receiving the user prompt 270, the chatbot service 264 builds a service request 272 that includes the user prompt 270. In some examples and features of the instant solution, the service request 272 may include a target AI model identifier, such as an identifier to a trained chatbot AI model 266. Once built, the service request 272 is delivered to the AI production system 230. Upon receipt of the service request 272, the AI production system 230 determines the target AI model, such as the trained chatbot AI model 266, and extracts the user prompt 270. In some examples and features of the instant solution, the AI production system transforms the user prompt 270 using Natural Language Understanding (NLU) or Natural Language Processing (NLP) techniques before delivering it to the trained chatbot AI model 266. Upon receipt of the possibly transformed user prompt 270, the trained chatbot AI model 266 determines an appropriate user response 274 and returns the user response 274 to the AI production system 230. In some examples and features of the instant solution, the trained chatbot AI model 266 utilizes neural networks or Natural Language Generation (NLG) techniques in order to determine the appropriate user response 274.

Upon receipt of the response, the AI production system 230 constructs and sends a service response 276 that contains the user response 274 back to the chatbot service 264. Upon receipt of the service response 276, the chatbot service 264 extracts the user response 274 and delivers it to the chatbot client 262, which emits it.

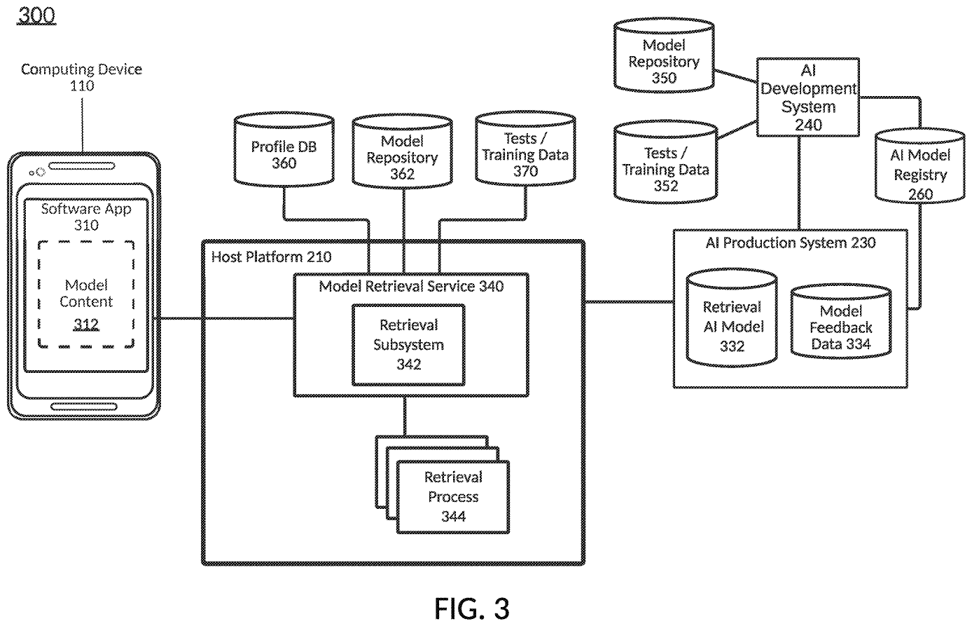

FIG. 3 illustrates an operating environment 300 for a RAG-based framework according to the examples and features of the instant solution.

In some examples and features of the instant solution, retrieval AI model 332 is trained using training data that identifies optimum AI models for particular tasks, accuracy levels of the AI optimum AI models, metrics of the optimum AI models, and the like, to determine an optimum model for a requested task and output content from the optimum AI model such as source code, an executable file, a method, an A PI, and the like. The retrieval AI model 332 is an example of AI Model 232 (see, for example, FIGS. 2A-2C). In some embodiments, the training data may also include profile data from a profile database 360, model metadata from a model repository 362, tests and/or training data used during development of A I models from a database 370, and the like, are examples of data source 250.

In some examples and features of the instant solution, the retrieval AI model 332 is trained using at least one neural network training method such as, but not limited to, gradient descent, stochastic gradient descent, random search, uniform search, basin hopping, and Krylov. In some examples and features of the instant solution, the retrieval AI model 332 is a single or multi-layer perceptron neural network, a feed-forward neural network, a radial basis functional neural network, a recurrent neural network, or a modular neural network.

In some examples and features of the instant solution, the retrieval AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data may include, but is not limited to, at least one of the profile database 360, the model repository 362, the database 370, and the like. In some examples and features of the instant solution, the training data for the retrieval AI model 332 may include, but is not limited to, internal data sources, external data sources, private data sources, public data sources, coding standards, or the like.

In some examples and features of the instant solution, the profile database 360 may store profiles for users including account data, passwords, usernames, payment card data, rights and restrictions, access rights to data, access rights to systems, and the like. In some examples and features of the instant solution, the model repository 362 may include executable files of the AI models, source code, model metadata, and the like. In some examples and features of the instant solution, the database 370 may include training data that is used to train the AI models, tests used to test the AI models during training including functionality tests, UI tests, and the like.

The model feedback records in the model feedback data 334 may include, but is not limited to, inputs received from a user, source device, graphical user interface, etc., which include feedback on whether a retrieved AI model is approved by the user or the like.

Once the retrieval AI model 332 is trained and validated, it is deployed to an AI production system 230 for use by a model retrieval service 340. The model retrieval service 340 is an example of software service 212.

In some examples and features of the instant solution, the software app 310, running on computing device 110, is an example of service client 182. The software app 310 may include a chat application that enables a user of the computing device 110 to converse with a chatbot inside the software app 310. The responses that are output by the chatbot may be generated by the model retrieval service 340, and may include model content 312, test content, training data, and the like. In some embodiments, the software app 310 may also request additional data from the user of the computing device 110 when the model retrieval service 340 does not have enough data to determine an optimum AI model. For example, the system may verify if certain elements have been received (e.g., task type, data type, etc.) If these elements are not present, the system may ask the user a question in a natural language, for the missing data.

In some examples and features of the instant solution, the model retrieval service 340 receives data from the software app 310. The data may include, but is not limited to, input content input by a user into the software app 310 including typed content, spoken content captured by a microphone, and the like.

Additionally, the model retrieval service 340 receives data about the computing device 110. The device data may include, but is not limited to, the media access control (MAC) address and the source internet protocol (IP) address of the computing device.

The model retrieval service 340 may include a retrieval subsystem 342 that can receive data from a chat window and execute a retrieval process 344 on the data to select an AI model from the model repository 362 based on the retrieval AI model 332 which can identify an optimum AI model in the model repository 362 for a type of task and a type of data. The retrieval subsystem 342 is an example of decision subsystem 224 (see, for example, FIGS. 2A-2C) .

In some examples and features of the instant solution, the model retrieval service 340 may continue to receive and process data from the software app 310 in parallel to the model retrieval process being performed.

The retrieval AI model 332 may be part of the AI production system 230. Here, the retrieval AI model 332 may be stored within an AI model registry 260 and may be trained and/or retrained by an AI development system 240, for example, based on model metadata, model types, and the like, stored in a model repository 350, based on tests and/or training data stored in a database 352, and the like.

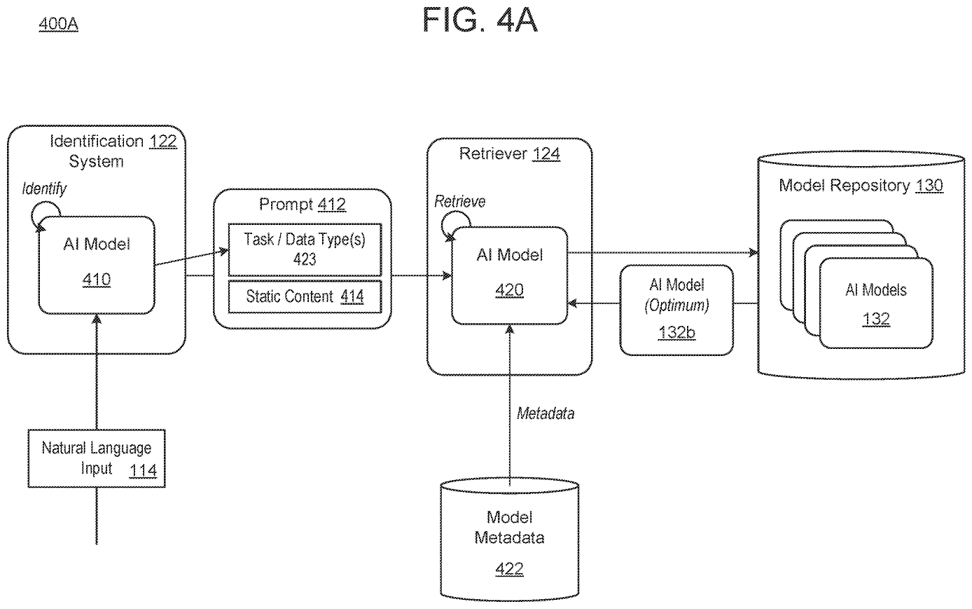

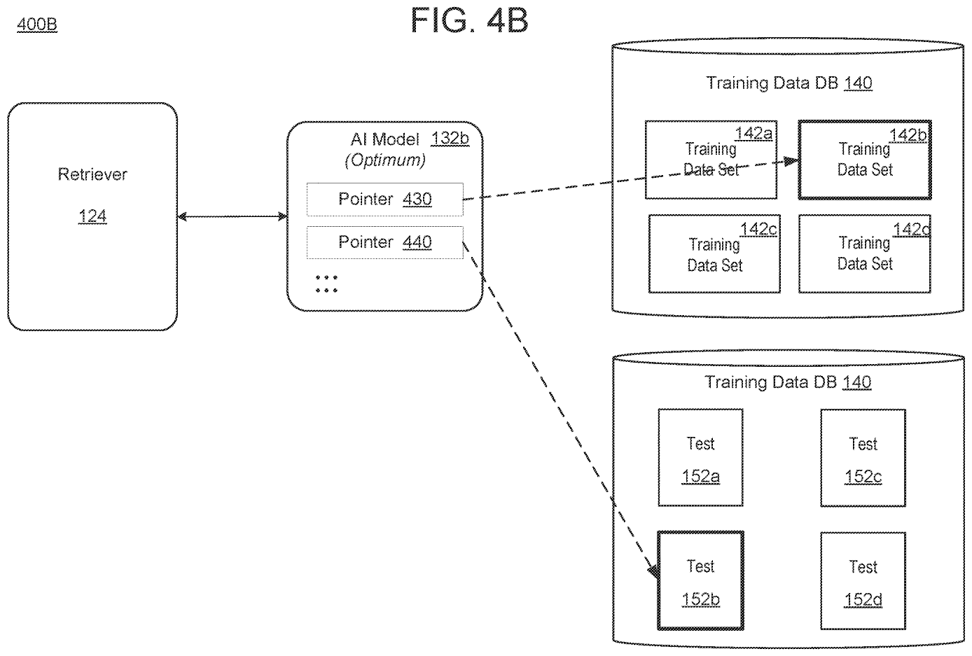

FIG. 4A illustrates a process 400A of retrieving an AI model according to the examples and features of the instant solution. Referring to FIG. 4A, the identification system 122 shown in FIG. 1A may include an AI model 410 that is trained to identify predefined attributes from the natural language input 114. For example, the attributes may be data values corresponding to particular data types, categories, etc. For example, the AI model 410 may be trained to detect a type of predictive task (e.g., a task to be performed by an AI model) and a type of data that the AI model will use to perform the predictive task. The type of data may include data from a particular source, data of a particular type, data of a particular format, etc.

In the example of FIG. 4A, the AI model 410 identifies attributes 423 from the natural language input 114 which include a predictive task and a type of data. The identification system 122 may include a script or other code that can generate a prompt 412 that includes the attributes 423 and static content 414 that provides a particular task to be performed by a second AI model 420 included in the retriever 124. The prompt 412 is then fed to the second AI model 420 which is trained to identify an optimum AI model (e.g., the optimum AI model 132b) from among a plurality of available AI models in a model repository 130. The second AI model 420 may be trained using training data that maps predictive tasks and data combinations to a particular type or types of AI models.

In some embodiments, the second AI model 420 may ingest additional content to help identify the optimum AI model 132b. For example, the second AI model 420 may ingest metadata from a model metadata database 422.

In another example, FIG. 4A illustrates a retrieval-augmented generation RA G architecture for AI model selection, wherein the identification system 122 receives a natural language input 114 describing a dataset and a specific task. The identification system 122 extracts key attributes or Task/Data Type(s) 423 from the natural language query, such as the type of predictive task and the data type associated with the task. These attributes are parsed and structured into a prompt 412 that includes both dynamic query attributes and static content 414 relevant to model selection.

The retriever 124 processes the structured query prompt 412 and executes a retrieval process using an AI model 420 trained to determine the most relevant AI model for the specified task. The AI model 420 applies similarity analysis by comparing extracted attributes or Task/Data Type(s) 423 to metadata stored in the model metadata database 422. Based on this comparison, the retriever 124 identifies an optimum AI model 132b from the model repository 130 by leveraging a ranking mechanism that prioritizes models based on historical performance data, training conditions, and evaluation metrics.

Once the optimum AI model 132b is identified, the retriever 124 initiates a secondary retrieval process to obtain supplementary data associated with the model. This includes extracting training datasets 142b (FIG. 1A) from the training data database 140 (FIG. 1A) and retrieving the test 152b (FIG. 1A) from the test database 150 (FIG. 1A). The retriever 124 (FIG. 1A) generates a response containing the selected AI model, along with its corresponding training and testing datasets, ensuring that users receive comprehensive model information for evaluation and deployment. The identification system 122 (FIG. 1A) ensures that the retrieval pipeline continuously refines itself by integrating user feedback. The system logs user interactions and performance outcomes, updating the AI model 420 to improve future selection accuracy.

FIG. 4B illustrates a process 400B of retrieving training data and model tests according to the examples and features of the instant solution. Referring to FIG. 4B, the retriever 124 may use the optimum AI model 132b to also retrieve additional model content for the user including, but not limited to, training data, testing data, software tests, user interface tests, functional tests, and the like. For example, the optimum AI model 132b may include a file, document, etc. with pointers that identify where training data, tests, and the like, are stored and can be retrieved from.

In the example of FIG. 4B, the optimum AI model 132b includes a file with a pointer 430 that points to the training data set 142b used to train the optimum AI model 132b within the training data database 140. The pointer identifies the training data set 142b that was used during training of the optimum AI model 132b, and can be used to find and access the training data set 142b among the remaining training data sets including training data sets 142a, 142c, and 142d. The pointer 430 may include an index, a memory address, a URL, a topic, a table identifier, and the like. In addition, the optimum AI model 132b also includes an additional pointer 440 which points to a storage location of the test 152b used to test the optimum AI model 132b during training of the optimum AI model 132b. The additional pointer 440 can be used to find and access the tests that were used to test the optimum AI model among a plurality of other tests 152a, 152c, and 152d in the test database 150. The retriever 124 may retrieve executable code files of the optimum AI model 132b, the training data set 142b, and the test 152b, and post them to a chat window and share them with a user in the chat.

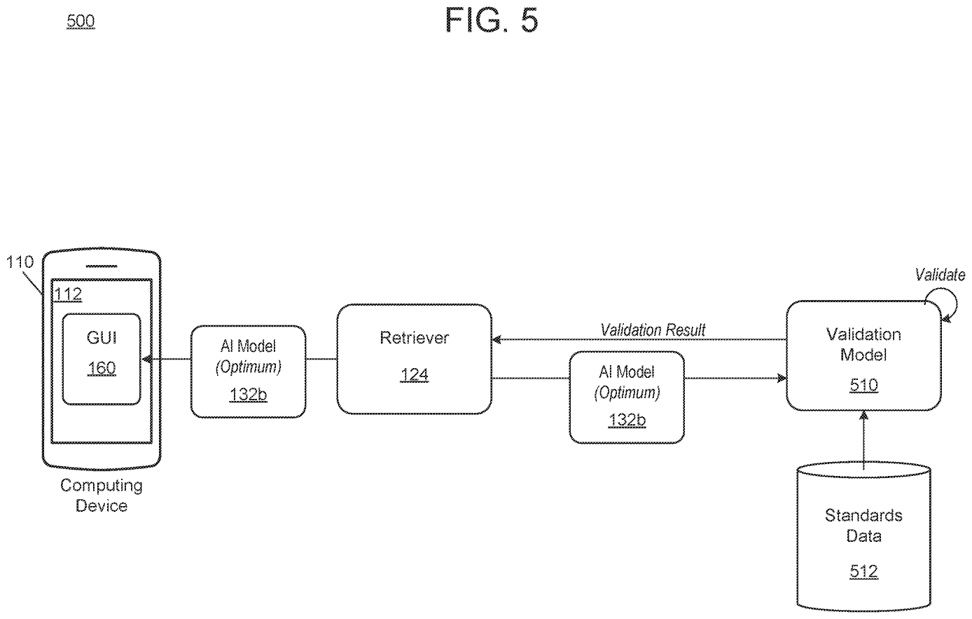

FIG. 5 illustrates a process 500 of validating the optimum AI model 132b prior to delivering the optimum AI model 132b to the chat window according to the examples and features of the instant solution. Referring to FIG. 5, in some embodiments, the host platform that hosts the RAG system described herein may also include a validation model 510 that is trained to validate underlying source code of an AI model against at least one standard such as industry best practices, internal best practices, coding guidelines, and the like. For example, the validation model 510 may be an AI model that receives, as input, the optimum AI model 132b (including the source code), and determines whether the source code satisfied predefined coding standards stored in a standards database 512.

The validation model 510 may ingest document content including manuals, best practice documents, and the like, from the standards database 512 during execution and validate the optimum AI model 132b based thereon. The retriever 124 may wait to output the optimum AI model 132b to the computing device 110 until a validation result/validation approval is received from the validation model 510.

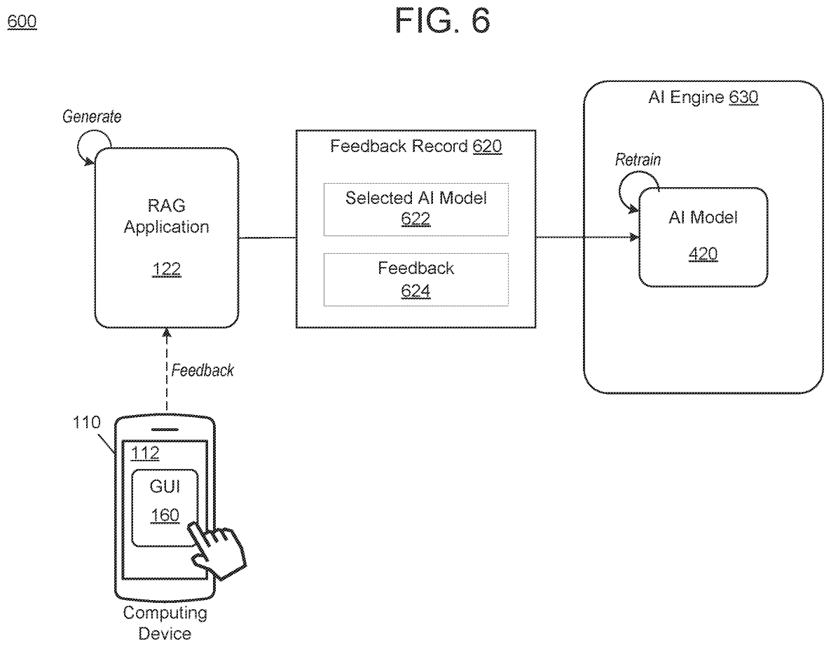

FIG. 6 illustrates a process 600 of retraining the second AI model 420 according to the examples and features of the instant solution. Referring to FIG. 6, the RA G application may receive feedback about the optimum AI model 132b posted in the chat window of the GUI 160. For example, the user of the computing device 110 may input feedback into the chat window or into the GUI 160 and submit the feedback to the RAG application 120. The feedback may indicate whether the optimum AI model 132b was accepted by the user or rejected.

The RAG application 120 may generate a feedback record 620 based on the feedback provided from the GUI 160. For example, the feedback record 620 may include the selected optimum AI model 622 (such as the optimum AI model 132b in the examples herein) and the feedback 624 from the user. The feedback record 620 may be input to an AI engine 630 which causes the second AI model 420 to execute on the feedback record 620 thereby retraining the second AI model 420 for subsequent retrieval operations based on the feedback record 620. The resulting retrained model can be used for subsequent determination of optimum AI models.

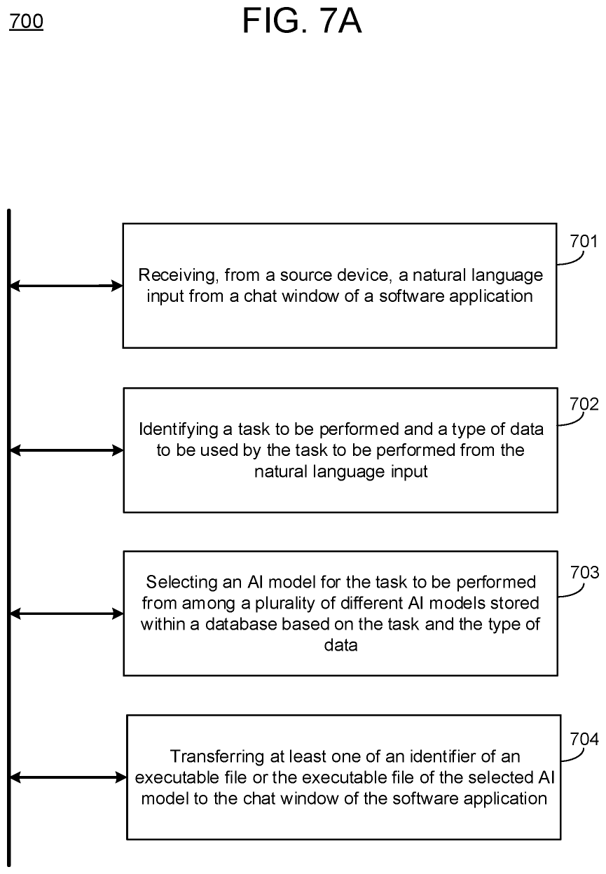

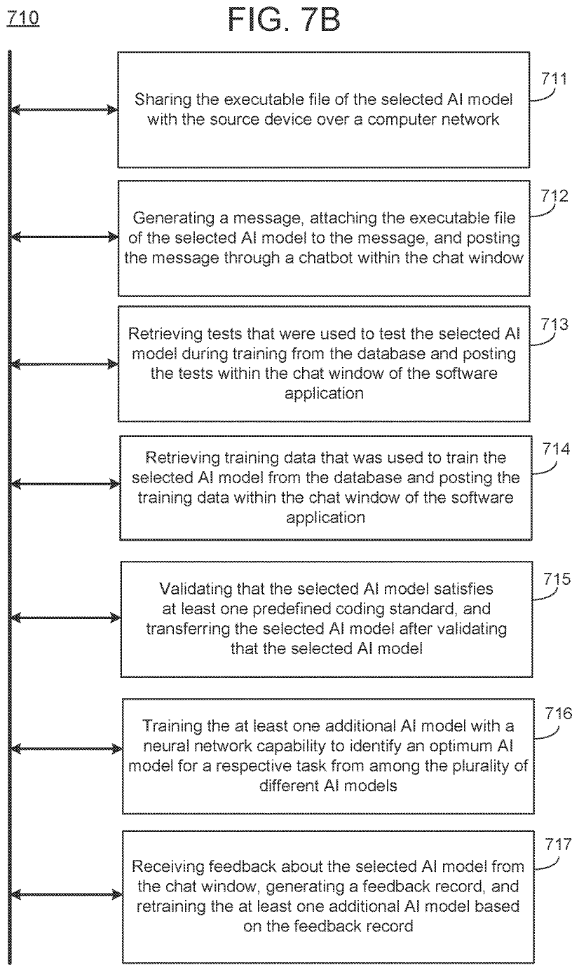

FIG. 7A illustrates a method 700 for recommending an AI model according to the examples and features of the instant solution. For example, the method 700 may be performed by a software application, a host platform, at least one processor, a storage device, and the like. Referring to FIG. 7A, in 701, the method may include receiving, from a source device, a natural language input from a chat window of a software application. In 702, the method may include identifying a task to be performed and a type of data to be used by the task to be performed from the natural language input. In 703, the method may include selecting an artificial intelligence (AI) model for the task to be performed from among a plurality of different AI models stored within a database based on execution of at least one additional AI model on the task and the type of data. In 704, the method may include transferring at least one of an identifier of an executable file or the executable file of the selected AI model to the chat window of the software application.

FIG. 7B illustrates an additional method 710 for recommending an AI model according to the examples and features of the instant solution. For example, the method 710 may be performed by a software application, a host platform, at least one processor, a storage device, and the like. Referring to FIG. 7B, in 711, the chat window includes a shared window for a host platform of the software application and the source device accessing the software application, and the method includes sharing the executable file of the selected AI model with the source device over a computer network. In 712, the method may include generating a message, attaching the executable file of the selected AI model to the message, and posting the message through a chatbot within the chat window.

In 713, the method may include retrieving tests that were used to test the selected AI model during training from the database and posting the tests within the chat window of the software application. In 714, the method may include retrieving training data that was used to train the selected AI model from the database and posting the training data within the chat window of the software application. In 715, the method may include validating that the selected A I model satisfies at least one predefined coding standard based on execution of the at least one additional AI model on source code of the selected AI model, and transferring the selected AI model after validating that the selected AI model satisfies the at least one predefined coding standard.

In 716, the method may include training the at least one additional AI model with a neural network capability to identify an optimum AI model for a respective task from among the plurality of different AI models based on execution of the at least one additional AI model on mappings of optimum AI models to predefined tasks. In 717, the method may include receiving feedback about the selected AI model from the chat window, generating a feedback record that includes an identifier of the selected AI model and the feedback, and retraining the at least one additional AI model based on execution of the at least one additional AI model on the feedback record.

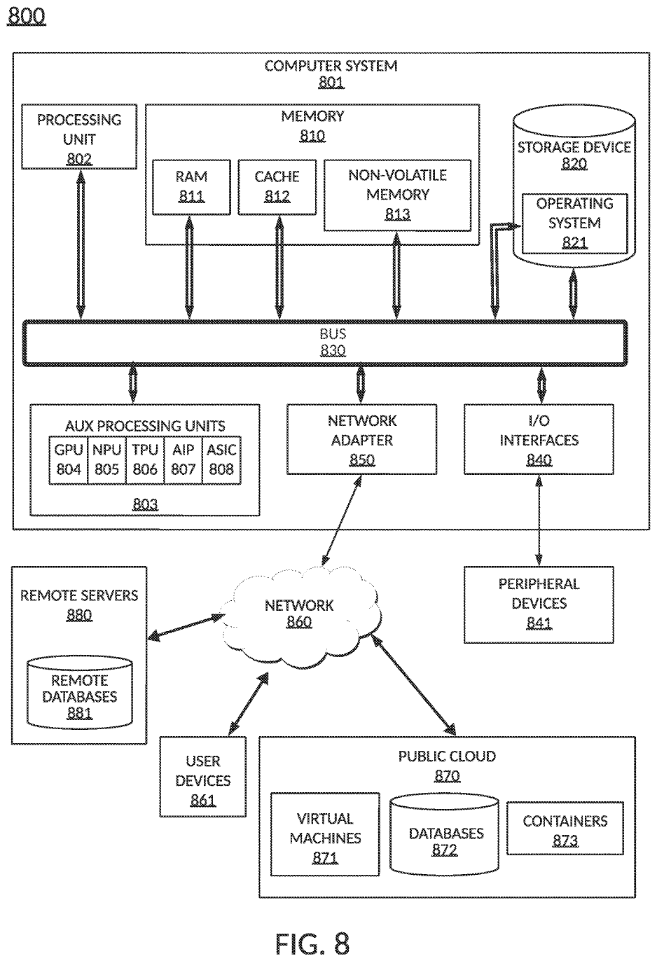

The examples and features of the instant solution may be implemented in at least one of the elements described or depicted herein, including for example, the elements described or depicted in FIG. 8. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM) , or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates a computing environment according to the instant solution's example features, structures, or characteristics. FIG. 8 is not intended to suggest any limitation as to the scope of use or functionality of features, structures, or characteristics of the instant solution of the application described herein. Regardless, the computing environment 800 can be implemented to perform any of the functionalities described herein. In computing environment 800, there is a computer system 801, operational within numerous other general-purpose or special-purpose computing system environments or configurations.

Computer system 801 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 860 or querying a database. Depending upon the technology, the performance of a computer-implemented method may be distributed among multiple computers and among multiple locations. However, in this presentation of the computing environment 800, a detailed discussion is focused on a single computer, computer system 801, to keep the presentation as simple as possible.

Computer system 801 may be located in a cloud, even though it is not shown in a cloud in FIG. 8. On the other hand, computer system 801 may not be in a cloud except to any extent as may be affirmatively indicated. Computer system 801 may be described in the general context of computer system-executable instructions, such as program modules, executed by a computer system 801. Generally, program modules may include routines, programs, objects, components, logic, data structures, and so on that perform tasks or implement certain abstract data types. A s shown in FIG. 8, computer system 801 in computing environment 800 is shown in the form of a general-purpose computing device. The components of computer system 801 may include but are not limited to, at least one processor such as processing unit 802, a system memory 810, and a bus 830 that couples various system components, including system memory 810 to the processing unit 802.

Processing unit 802 includes at least one computer processor of any type now known or to be developed. The processing unit 802 may contain circuitry distributed over multiple integrated circuit chips. The processing unit 802 may also implement multiple processor threads and multiple processor cores. Cache 812 is a memory that may be in the processor chip package(s) or located “off-chip,” as depicted in FIG. 8. Cache 812 is typically used for data or code accessed by the threads or cores running on the processing unit 802. In some computing environments, processing unit 802 may be designed to work with qubits and perform quantum computing.

The Auxiliary Processing Units (A PU) 803 may contain at least one Graphics Processing Unit (GPU) 804, Neural Processing Unit (NPU) 805, Tensor Processing Unit (TPU) 806, AI Processor (AIP) 807, or other Application Specific Integrated Circuit (A SIC) 808. The at least one A PU 803 may contain circuitry distributed over multiple integrated circuit chips. Each A PU 803 may implement multiple processor threads and multiple processor cores. Each APU 803 may include at least one of onboard memory, onboard memory cache, and onboard instruction cache. Each A PU may be communicatively coupled to the bus 830 and configure to communicate with other system components, including a processing unit 802, the cache 812, RAM 811, non-volatile memory 813 such as RAM, operating system 821, Network adapter 850, and Input/Output interfaces 840. In some computing environments, at least one of the at least one A PU 803 may be designed to work with qubits and perform quantum computing.

Memory 810 is any volatile memory now known or to be developed in the future. Examples include dynamic random-access memory (RAM) 811 or static type of the RAM 811. Typically, the volatile memory is characterized by random access, but this may not be the characterization unless affirmatively indicated. In computer system 801, memory 810 is in a single package. It is internal to computer system 801, but alternatively or additionally, the volatile memory may be distributed over multiple packages and/or located externally with respect to computer system 801. By way of example, memory 810 can be provided for reading from and writing to a non-removable, non-volatile magnetic media (shown as storage device 820, and typically called a “hard drive”). Memory 810 may include at least one program product having a set (e.g., at least one) of program modules configured to carry out the functions of various features, structures, or characteristics of the instant solution of the application. The computer system 801 may include the cache 812, a specialized volatile memory generally faster than the RAM 811 and generally located closer to the processing unit 802. Cache 812 stores frequently accessed data and instructions accessed by the processing unit 802 to speed up processing time. The computer system 801 may also include non-volatile memory 813 in the form of ROM, PROM, EEPROM, and flash memory. Non-volatile memory 813 often contains programming instructions for starting the computer, including the basic input/output system (BIOS) and information to start the operating system 821.

Computer system 801 may include a removable/non-removable, volatile/non-volatile computer storage device 820. For example, storage device 820 can be a non-removable, non-volatile magnetic media (not shown and typically called a “hard drive”). At least one data interface can connect it to the bus 830. In features, structures, or characteristics of the instant solution where computer system 801 has a large amount of storage (for example, where computer system 801 locally stores and manages a large database), then this storage may be provided by storage devices 820 designed for storing very large amounts of data, such as a storage area network (SAN) that is shared by multiple, geographically distributed computers.

The operating system 821 is software that manages computer system 801 hardware resources and provides common services for computer programs. Operating system 821 may take several forms, such as various known proprietary operating systems or open-source Portable Operating System Interface type operating systems that employ a kernel.

The bus 830 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (M CA) buses, Enhanced ISA (EISA) buses, Video Electronics Standards Association (VESA) local buses, and Peripheral Component Interconnect (PCI) bus. The bus 830 is the signal conduction path that allows the various components of computer system 801 to communicate.

Computer system 801 may communicate with at least one peripheral device, 841, via the I/O interface, 840. Such devices may include a keyboard, a pointing device, a display, etc. ; at least one device that enables a user to interact with computer system 801; and/or any devices (e.g., network card, modem, etc.) that enable computer system 801 to communicate with at least one other computing device. Such communication can occur via the I/O interface 840. As depicted, the I/O interface 840 communicates with the other components of computer system 801 via the bus 830.

Network adapter 850 enables the computer system 801 to connect and communicate with at least one network 860, such as a local area network (LAN), a wide area network (WAN), and/or a public network (e.g., the Internet). It bridges the bus 830 and the external network, exchanging data efficiently and reliably. The network adapter 850 may include hardware, such as modems or Wi-Fi signal transceivers, and software for packetizing and/or de-packetizing data for communication network transmission. Network adapter 850 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 860 is any computer network that can receive and/or transmit data. Network 860 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 860 may be replaced and/or supplemented by LA Ns designed to communicate data between devices in a local area, such as a Wi-Fi network. The network 860 typically includes computer hardware such as copper transmission cables, optical transmission fibers, wireless transmission, routers, firewalls, switches, gateway computers, edge servers, and network infrastructure known now or to be developed in the future. Computer system 801 connects to network 860 via network adapter 850 and bus 830.

User devices 861 are any computer systems used and controlled by an end user in connection with computer system 801. For example, in a hypothetical case where computer system 801 is designed to provide a recommendation to an end user, this recommendation may typically be communicated from network adapter 850 of computer system 801 through network 860 to a user device 861, allowing user device 861 to display, or otherwise present, the recommendation to an end user. U ser devices can be a wide array, including personal computers, laptops, tablets, hand-held, mobile phones, etc.

A public cloud 870 is an on-demand availability of computer system resources, including data storage and computing power, without direct active management by the user. Public clouds 870 are often distributed, with data centers in multiple locations for availability and performance. Computing resources on public clouds 870 are shared across multiple tenants through virtual computing environments comprising virtual machines 871, databases 872, containers 873, and other resources. A container 873 is an isolated, lightweight software for running and/or hosting a software application on the operating system 821. Containers 873 are built on top of the host operating system's kernel and contain software applications and some lightweight operating system A Pls and services. In contrast, virtual machine 871 is a software layer with an operating system 821 and kernel. Virtual machines 871 are built on top of a hypervisor emulation layer designed to abstract a host computer's hardware from the operating software environment. Public clouds 870 generally offers databases 872, abstracting high-level database management activities. At least one element described or depicted in FIG. 8 can perform at least one of the actions, functionalities, or features described or depicted herein.

Remote servers 880 are any computers that serve at least some data and/or functionality over a network 860, for example, WAN, a virtual private network (VPN), a private cloud, or via the Internet to computer system 801. These networks 860 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 880 can also host remote databases 881, with the database located on one remote server 880 or distributed across multiple remote servers 880. Remote databases 881 are accessible from database client applications installed locally on the remote server 880, other remote servers 880, user devices 861, or computer system 801 across a network 860. An AI/ML model described or depicted here may reside fully or partially on any of the elements described or depicted in FIG. 8.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA) , a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
at least one processor which is communicably coupled to the memory, wherein the at least one processor is configured to:
receive, from a source device, a natural language input from a chat window of a software application;
identify a task to be performed and a type of data to be used by the task to be performed from the natural language input;
select an artificial intelligence (AI) model for the task to be performed from among a plurality of different AI models stored within a database based on execution of at least one additional AI model on the task and the type of data; and
transfer at least one of an identifier of an executable file or the executable file of the selected AI model to the chat window of the software application.

2. The apparatus of claim 1, wherein the chat window comprises a shared window for a host platform of the software application and the source device accessing the software application, and the at least one processor is configured to share the executable file of the selected AI model with the source device over a computer network, wherein an AI agent performs an action related to the transfer.

3. The apparatus of claim 1, wherein the at least one processor is configured to generate a message, attach the executable file of the selected AI model to the message, and post the message through a chatbot within the chat window.

4. The apparatus of claim 1, wherein the at least one processor is further configured to retrieve tests that were used to test the selected AI model during training from the database and post the tests within the chat window of the software application.

5. The apparatus of claim 1, wherein the at least one processor is further configured to retrieve training data that was used to train the selected AI model from the database and post the training data within the chat window of the software application.

6. The apparatus of claim 1, wherein the at least one processor is further configured to validate that the selected AI model satisfies at least one predefined coding standard based on execution of the at least one additional AI model on source code of the selected AI model, and transfer the selected AI model after validating that the selected AI model satisfies the at least one predefined coding standard.

7. The apparatus of claim 1, wherein the at least one processor is further configured to train the at least one additional AI model with a neural network capability to identify an optimum AI model for a respective task from among the plurality of different AI models based on execution of the at least one additional AI model on mappings of optimum AI models to predefined tasks.

8. The apparatus of claim 1, wherein the at least one processor is further configured to receive feedback about the selected AI model from the chat window, generate a feedback record that includes an identifier of the selected AI model and the feedback, and retrain the at least one additional AI model based on execution of the at least one additional AI model on the feedback record.

9. A method comprising:
receiving, from a source device, a natural language input from a chat window of a software application;
identifying a task to be performed and a type of data to be used by the task to be performed from the natural language input;
selecting an artificial intelligence (AI) model for the task to be performed from among a plurality of different AI models stored within a database based on execution of at least one additional AI model on the task and the type of data; and
transferring at least one of an identifier of an executable file or the executable file of the selected AI model to the chat window of the software application.

10. The method of claim 9, wherein the chat window comprises a shared window for a host platform of the software application and the source device accessing the software application, and the transferring comprises sharing the executable file of the selected AI model with the source device over a computer network, wherein an AI agent performs an action related to the transferring.

11. The method of claim 9, wherein the transferring comprises generating a message, attaching the executable file of the selected AI model to the message, and posting the message through a chatbot within the chat window.

12. The method of claim 9, further comprising retrieving tests that were used to test the selected AI model during training from the database and posting the tests within the chat window of the software application.

13. The method of claim 9, further comprising retrieving training data that was used to train the selected AI model from the database and posting the training data within the chat window of the software application.

14. The method of claim 9, further comprising validating that the selected AI model satisfies at least one predefined coding standard based on execution of the at least one additional AI model on source code of the selected AI model, and transferring the selected AI model after validating that the selected AI model satisfies the at least one predefined coding standard.

15. The method of claim 9, further comprising training the at least one additional AI model with a neural network capability to identify an optimum AI model for a respective task from among the plurality of different AI models based on execution of the at least one additional AI model on mappings of optimum AI models to predefined tasks.

16. The method of claim 9, further comprising receiving feedback about the selected AI model from the chat window, generating a feedback record that includes an identifier of the selected AI model and the feedback, and retraining the at least one additional AI model based on execution of the at least one additional AI model on the feedback record.

17. A computer-readable storage medium comprising instructions which when executed by a processor cause the processor to perform:
receiving, from a source device, a natural language input from a chat window of a software application;
identifying a task to be performed and a type of data to be used by the task to be performed from the natural language input;
selecting an artificial intelligence (AI) model for the task to be performed from among a plurality of different AI models stored within a database based on execution of at least one additional AI model on the task and the type of data; and
transferring at least one of an identifier of an executable file or the executable file of the selected AI model to the chat window of the software application.

18. The computer-readable storage medium of claim 17, wherein the chat window comprises a shared window for a host platform of the software application and the source device accessing the software application, and the transferring comprises sharing the executable file of the selected AI model with the source device over a computer network.

19. The computer-readable storage medium of claim 17, wherein the transferring comprises generating a message, attaching the executable file of the selected AI model to the message, and posting the message through a chatbot within the chat window.

20. The computer-readable storage medium of claim 17, wherein the processor is further configured to perform retrieving tests that were used to test the selected AI model during training from the database and posts the tests within the chat window of the software application.
